(19) United States
(12) Patent Application Publication
(10) Pub. No.: US 2020/0007857 A1
(43) Pub. Date: Jan. 2, 2020

(54) DISPLAY DEVICE

(71) Applicant: Panasonic Intellectual Property Management Co., Ltd., Osaka (JP)

(72) Inventors: Shigeo KASAHARA, Hyogo (JP); Kazushige TAKAGI, Osaka (JP); Manabu INOUE, Osaka (JP)

(21) Appl. No.: 16/565,986

(22) Filed: Sep. 10, 2019

Related U.S. Application Data
(63) Continuation of application No. PCT/JP2018/008924, filed on Mar. 8, 2018.

(30) Foreign Application Priority Data
Mar. 17, 2017 (JP) 2017-053670

(51) Int. Cl. H04N 13/395; G02B 27/22; G02F 1/1347; H04N 13/398; G02B 27/24; G02B 27/26

(52) U.S. Cl. CPC H04N 13/395; G02B 27/2278; G02B 27/26; H04N 13/398; G02B 27/24; G02F 1/13471

(57) ABSTRACT

Display device (2) includes display panel (20) that displays an image, backlight (16) that irradiates a back surface of display panel (20) with light, polarization modulator (10) that modulates light representing the image of display panel (20) into either one of first polarized light and second polarized light that differ in polarization direction, first mirror (12) that is inclined relative to display panel (20), reflects toward user (6) the first polarized light that comes from polarization modulator (10), and transmits the second polarized light that comes from polarization modulator (10), and second mirror (14) that is in spaced and opposed relation to first mirror (12) and reflects toward user (6) the second polarized light that passes through first mirror (12).

### TECHNICAL FIELD

The present disclosure relates to a display device that displays images.

### BACKGROUND ART

A depth-fused 3D (DFD) display device is known as one of display devices that display images. This type of display device includes two transparent liquid crystal display (LCD) panels that are stacked in spaced relationship, and light coming from a backlight passes through these two LCD panels. Changing a luminance ratio between images displayed on the respective LCD panels effects display of a stereoscopic image through use of an optical illusion phenomenon in which the two images are fused into one image.

### CITATION LIST

### Patent Literature

PTL 1: Unexamined Japanese Patent Publication No. 2000-214413

### SUMMARY OF THE INVENTION

The present disclosure provides a display device that can increase utilization efficiency of light of a backlight.

A display device according to the present disclosure includes a display panel that displays an image, a backlight that irradiates a back surface of the display panel with light, a polarization modulator that modulates light representing the image of the display panel into either one of first polarized light and second polarized light that differ in polarization direction, a first mirror that is inclined relative to the display panel, reflects toward a user the first polarized light that comes from the polarization modulator, and transmits the second polarized light that comes from the polarization modulator, and a second mirror that is in spaced and parallel relation to the first mirror and reflects toward the user the second polarized light that passes through the first mirror.

The display device according to the present disclosure can increase utilization efficiency of the light of the backlight.

### BRIEF DESCRIPTION OF THE DRAWINGS

FIG. 1 illustrates a configuration of a display device according to a first exemplary embodiment.

FIG. 2 is a block diagram illustrating an electrical configuration of the display device according to the first exemplary embodiment (and a second exemplary embodiment).

FIG. 3 is a sectional view illustrating structure of a polarization modulator of the display device according to the first exemplary embodiment.

FIG. 4 illustrates operation of the polarization modulator of the display device according to the first exemplary embodiment.

FIG. 5 illustrates operation of a polarization modulator according to a modification of the first exemplary embodiment.

FIG. 6 is a timing chart illustrating operation of the display device according to the first exemplary embodiment.

FIG. 7 illustrates an image that is displayed by the display device according to the first exemplary embodiment.

FIG. 8 illustrates the operation of the display device according to the first exemplary embodiment.

FIG. 9 illustrates the operation of the display device according to the first exemplary embodiment.

FIG. 10 is a timing chart illustrating operation of a display device according to the second exemplary embodiment.

FIG. 11 is a block diagram illustrating an electrical configuration of a display device according to a third exemplary embodiment.

FIG. 12 is a timing chart illustrating operation of the display device according to the third exemplary embodiment.

FIG. 13 illustrates a configuration of a display device according to a fourth exemplary embodiment.

FIG. 14A illustrates structure of a polarization modulator of the display device according to the fourth exemplary embodiment.

FIG. 14B illustrates the structure of the polarization modulator of the display device according to the fourth exemplary embodiment.

FIG. 15 illustrates the structure of the polarization modulator of the display device according to the fourth exemplary embodiment.

FIG. 16A illustrates an image that is displayed by the display device according to the fourth exemplary embodiment.

FIG. 16B illustrates the image that is displayed by the display device according to the fourth exemplary embodiment.

FIG. 17A illustrates structure of a polarization modulator according to a first modification of the fourth exemplary embodiment.

FIG. 17B illustrates structure of a polarization modulator according to a second modification of the fourth exemplary embodiment.

FIG. 17C illustrates structure of a polarization modulator according to a third modification of the fourth exemplary embodiment.

FIG. 17D illustrates structure of a polarization modulator according to a fourth modification of the fourth exemplary embodiment.

FIG. 17E illustrates structure of a polarization modulator according to a fifth modification of the fourth exemplary embodiment.

FIG. 17F illustrates structure of a polarization modulator according to a sixth modification of the fourth exemplary embodiment.

FIG. 18 illustrates a configuration of a display device according to a fifth exemplary embodiment.

FIG. 19A illustrates structure of a polarization modulator of the display device according to the fifth exemplary embodiment.

FIG. 19B illustrates the structure of the polarization modulator of the display device according to the fifth exemplary embodiment.

FIG. 20 illustrates the structure of the polarization modulator of the display device according to the fifth exemplary embodiment.

FIG. 21 illustrates a configuration of a display device according to a sixth exemplary embodiment.

FIG. 22 illustrates a configuration of a display device according to a seventh exemplary embodiment.

### DESCRIPTION OF EMBODIMENTS

Exemplary embodiments are hereinafter described in detail with reference to the drawings as appropriate. However, unnecessarily detailed descriptions may be omitted. For example, detailed descriptions of already well-known matters and repeated descriptions of substantially the same configuration may be omitted. This is to avoid unnecessary redundancy in the following description and to facilitate understanding by those skilled in the art.

It is to be noted that the appended drawings and the following description are provided by the inventors to allow those skilled in the art to fully understand the present disclosure and are not intended to limit the subject matter described in the claims.

### First Exemplary Embodiment

### [1-1. Entire Configuration of Display Device]

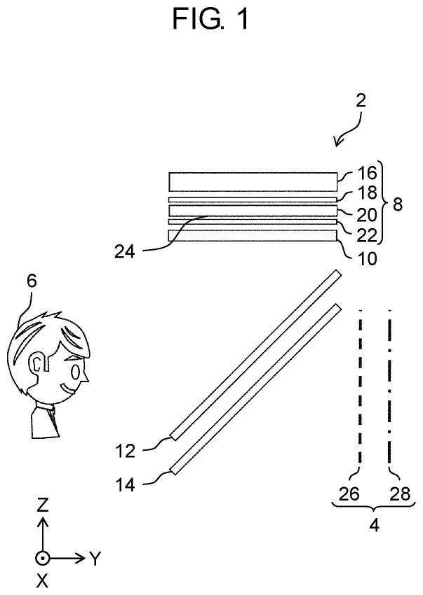

With reference to FIG. 1, a description is provided of an entire configuration of display device 2 according to the first exemplary embodiment. FIG. 1 illustrates the configuration of display device 2 according to the first exemplary embodiment.

Display device 2 is a DFD liquid crystal display device. Display device 2 is mounted, for example, to a vehicle such as an automobile to display for user 6 stereoscopic image 4 of, for example, a vehicle speedometer.

As illustrated in FIG. 1, display device 2 includes liquid crystal display module 8, polarization modulator 10, first mirror 12, and second mirror 14.

Liquid crystal display module 8 includes backlight 16, rear polarizing film 18, display panel 20, and front polarizing film 22.

Backlight 16 is disposed to face rear polarizing film 18. Backlight 16 irradiates a back surface (opposite to liquid crystal display part 24) of display panel 20 with light via rear polarizing film 18. It is to be noted that the light coming from backlight 16 includes light having any polarization direction.

Rear polarizing film 18 is disposed between backlight 16 and display panel 20 to face the back surface of display panel 20. Rear polarizing film 18 has a first transmission axis that indicates a polarization direction of light that passes through rear polarizing film 18. This means that included in the light entering rear polarizing film 18 from backlight 16, only the light having the polarization direction substantially parallel to the first transmission axis is transmitted by rear polarizing film 18.

Display panel 20 is, for example, a liquid crystal display panel which transmits visible light. A more specific example of display panel 20 is a twisted nematic liquid crystal display panel in which liquid crystal molecules are oriented to have a 90° twist. Liquid crystal display part 24 that displays an image is formed at a front surface of display panel 20.

It is to be noted that display panel 20 is not limited to the twisted nematic liquid crystal display panel and may even be, for example, an in-plane switching liquid crystal display panel, a vertical alignment liquid crystal display panel, a blue-phase liquid crystal display panel, a ferroelectric liquid crystal display panel, or an optically compensated bend (OCB) liquid crystal display panel.

Front polarizing film 22 is disposed to face liquid crystal display part 24 of display panel 20. Front polarizing film 22 has a second transmission axis that indicates a polarization direction of light that passes through front polarizing film 22. This means that included in the light entering front polarizing film 22 from liquid crystal display part 24 of display panel 20, only the light having the polarization direction substantially parallel to the second transmission axis is transmitted by front polarizing film 22. It is to be noted that the second transmission axis is substantially perpendicular in direction to the first transmission axis. The light exiting from front polarizing film 22 is, for example, S-polarized light (described later).

Polarization modulator 10 is what is called an active retarder. Polarization modulator 10 modulates the light representing the image of display panel 20 (i.e., the light exiting from front polarizing film 22) into either one of the S-polarized light (an example of first polarized light) and P-polarized light (an example of second polarized light) that have respective polarization directions differing by 90°. The S-polarized light is linearly polarized light having the first polarization direction (along an X-axis). The P-polarized light is linearly polarized light having the second polarization direction (along a Y-axis) differing from the first polarization direction by 90°.

First mirror 12 is, for example, a polarization beam splitter and is inclined at, for example, 45° relative to display panel 20. First mirror 12 reflects toward user 6 the S-polarized light that comes from polarization modulator 10 and transmits the P-polarized light that comes from polarization modulator 10. The angle at which first mirror 12 is inclined relative to display panel 20 is, in the present exemplary embodiment, 45° which is not limiting but may be an angle of choice.

Second mirror 14 is, for example, a reflecting mirror and is disposed in spaced and opposed relation to first mirror 12. Second mirror 14 substantially parallels first mirror 12. Second mirror 14 reflects toward user 6 the P-polarized light that passes through first mirror 12.

Display device 2 according to the first exemplary embodiment is a 3D display that displays stereoscopic image 4 for user 6. Front image 26 is displayed, as is described later, at a position that is in substantially symmetrical relation to user 6 with respect to first mirror 12, while back image 28 is displayed, as is described later, at a position that is in substantially symmetrical relation to user 6 with respect to second mirror 14. First mirror 12 and second mirror 14 are disposed in spaced relation to each other, so that front image 26 and back image 28 are displayed respectively at the positions that are different in a depthwise direction (along the Y-axis). Front image 26 and back image 28 have the same content but differ in luminance. Thus stereoscopic image 4 is displayed using an optical illusion phenomenon in which front image 26 and back image 28 are fused into one image.

### [1-2. Electrical Configuration of Display Device]

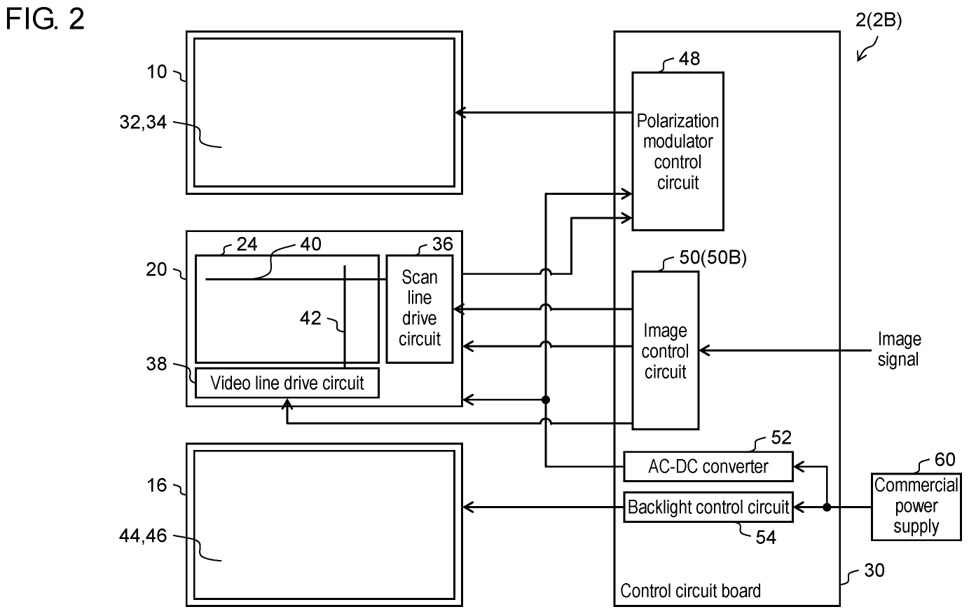

With reference to FIG. 2, a description is provided next of an electrical configuration of display device 2 according to the first exemplary embodiment. FIG. 2 is a block diagram illustrating the electrical configuration of display device 2 according to the first exemplary embodiment.

As illustrated in FIG. 2, the electrical configuration of display device 2 includes polarization modulator 10, display panel 20, backlight 16, and control circuit board 30.

Polarization modulator 10 includes a pair of transparent electrodes 32 and 34 between which a drive voltage is applied by polarization modulator control circuit 48.

Display panel 20 includes liquid crystal display part 24, scan line drive circuit 36, and video line drive circuit 38. Liquid crystal display part 24 has an arrangement of a plurality of scan lines 40 extending from scan line drive circuit 36 and an arrangement of a plurality of video lines 42 extending from video line drive circuit 38.

Backlight 16 includes light emitting diode (LED) light source 44 and light guide plate 46 that guides light of LED light source 44 toward rear polarizing film 18. LED light source 44 of backlight 16 may be disposed as a direct type or an edge light type. It is to be noted that backlight 16 may also include a diffuser or the like that uniformly diffuses light coming from light guide plate 46.

Control circuit board 30 is electrically connected to polarization modulator 10, display panel 20, and backlight 16. Control circuit board 30 supplies power, control signals, and others to polarization modulator 10, display panel 20, and backlight 16. Control circuit board 30 includes polarization modulator control circuit 48 (an example of a drive controller), image control circuit 50 (an example of a display controller), AC-DC converter 52, and backlight control circuit 54 (an example of a lighting controller).

Based on a vertical synchronizing signal coming from display panel 20, polarization modulator control circuit 48 controls the drive voltage to apply between the pair of transparent electrodes 32 and 34 of polarization modulator 10. The drive voltage is, for example, a rectangular-wave voltage with a frequency ranging from 1 kHz to 2 kHz inclusive.

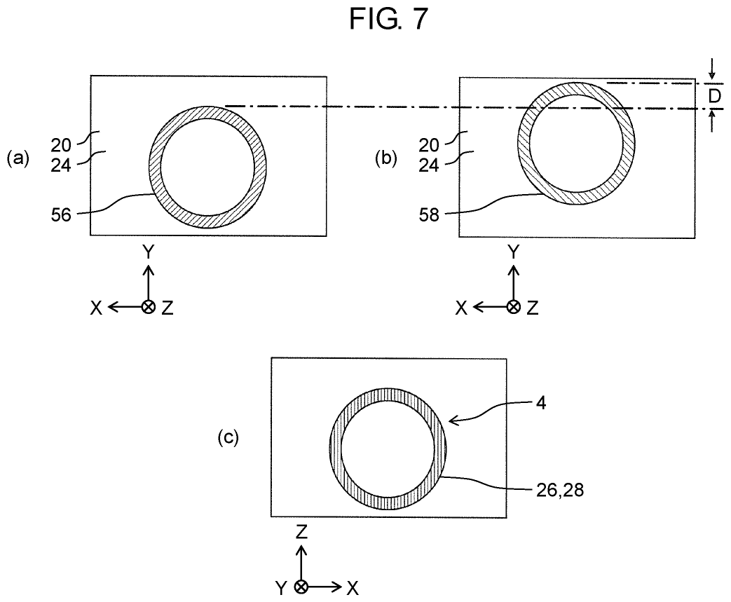

Based on an image signal obtained from outside control circuit board 30, image control circuit 50 generates the vertical synchronizing signal, a grayscale voltage, a common voltage, and others and supplies these to display panel 20. Accordingly, display panel 20 drives scan line drive circuit 36 and video line drive circuit 38 to operate scan lines 40 and video lines 42. Consequently, based on the vertical synchronizing signal, image control circuit 50 repeatedly causes first image 56 and second image 58 (refer to parts (a) and (b) of FIG. 7 that are described later) to be displayed alternately on liquid crystal display part 24 of display panel 20 with a predetermined periodicity (e.g., 60 Hz). This is when image control circuit 50 causes first image 56 and second image 58 to differ in luminance. First image 56 and second image 58 are images that respectively form above-mentioned front image 26 and above-mentioned back image 28.

AC-DC converter 52 converts alternating-current power that is supplied from commercial power supply 60 to direct-current power and supplies the converted direct-current power to display panel 20 and polarization modulator control circuit 48.

Based on the alternating-current power that is supplied from commercial power supply 60, backlight control circuit 54 controls lighting of LED light source 44 of backlight 16.

### [1-3. Structure of Polarization Modulator]

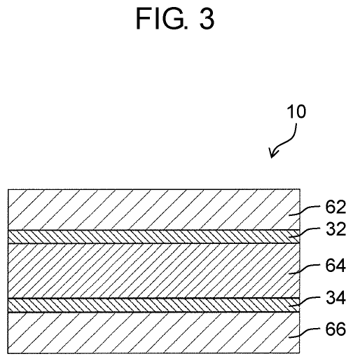

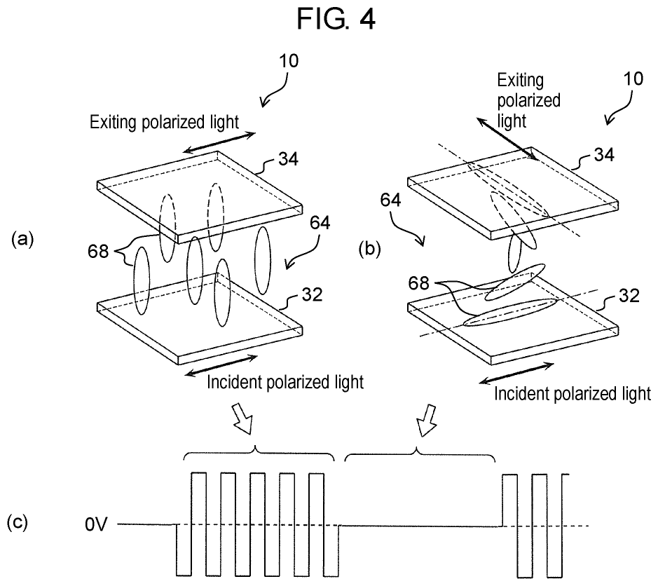

With reference to FIGS. 3 and 4, a description is provided next of structure of polarization modulator 10. FIG. 3 is a sectional view illustrating the structure of polarization modulator 10 of display device 2 according to the first exemplary embodiment. FIG. 4 illustrates operation of polarization modulator 10 of display device 2 according to the first exemplary embodiment. It is to be noted that part (a) of FIG. 4 illustrates how polarization modulator 10 operates when the drive voltage is applied between the pair of transparent electrodes 32 and 34. Part (b) of FIG. 4 illustrates how polarization modulator 10 operates when the drive voltage is not applied between the pair of transparent electrodes 32 and 34. Part (c) of FIG. 4 illustrates the drive voltage that is applied between the pair of transparent electrodes 32 and 34.

As illustrated in FIG. 3, glass substrate 62, transparent electrode 32, liquid crystal layer 64, transparent electrode 34, and glass substrate 66 are stacked in this order to form polarization modulator 10. It is to be noted that an ultrathin alignment layer is stacked between transparent electrode 32 and liquid crystal layer 64 as well as between transparent electrode 34 and liquid crystal layer 64 to orient the liquid crystal molecules but is omitted from FIG. 3 for convenience of explanation.

Liquid crystal layer 64 is composed of, for example, a twisted nematic type of liquid crystal. As illustrated in parts (a) and (c) of FIG. 4, with the drive voltage being applied between the pair of transparent electrodes 32 and 34, the plurality of liquid crystal molecules 68 are being oriented, each in alignment with a direction from transparent electrode 32 toward transparent electrode 34. Here polarization modulator 10 is in a first state in which its polarization axis is directed at 0°. This means that the polarized light exiting from liquid crystal layer 64 has the same polarization direction as the polarized light incident on liquid crystal layer 64.

As illustrated in parts (b) and (c) of FIG. 4, with the drive voltage not being applied between the pair of transparent electrodes 32 and 34, the plurality of liquid crystal molecules 68 are being oriented (rubbed) to have a 90° twist. Here polarization modulator 10 is in a second state in which its polarization axis is directed at 90°. This means that the polarization direction of the polarized light exiting from liquid crystal layer 64 differs from the polarization direction of the polarized light incident on liquid crystal layer 64 by 90°.

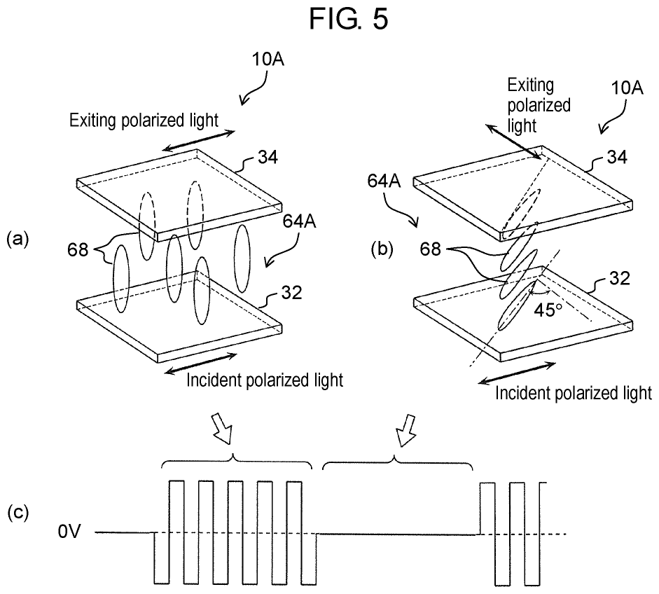

It is to be noted that liquid crystal layer 64 is composed of the twisted nematic type of liquid crystal in the present exemplary embodiment but is not limited to this. FIG. 5 illustrates operation of polarization modulator 10A according to a modification of the first exemplary embodiment. It is to be noted that part (a) of FIG. 5 illustrates how polarization modulator 10A operates when the drive voltage is applied between the pair of transparent electrodes 32 and 34. Part (b) of FIG. 5 illustrates how polarization modulator 10A operates when the drive voltage is not applied between the pair of transparent electrodes 32 and 34. Part (c) of FIG. 5 illustrates the drive voltage that is applied between the pair of transparent electrodes 32 and 34.

Liquid crystal layer 64A of polarization modulator 10A according to the modification is composed of a nematic type of liquid crystal as illustrated in FIG. 5. As illustrated in parts (a) and (c) of FIG. 5, with the drive voltage being applied between the pair of transparent electrodes 32 and 34, the plurality of liquid crystal molecules 68 are being oriented, each in alignment with the direction from transparent electrode 32 toward transparent electrode 34. Here polarization modulator 10A is in the first state in which its polarization axis is directed at 0°. This means that polarized light exiting from liquid crystal layer 64A has the same polarization direction as polarized light incident on liquid crystal layer 64A.

As illustrated in parts (b) and (c) of FIG. 5, with the drive voltage not being applied between the pair of transparent electrodes 32 and 34, the plurality of liquid crystal molecules 68 are being oriented to be each inclined at 45° relative to a polarization direction of polarized light exiting from liquid crystal layer 64A. Here polarization modulator 10A is in the second state in which its polarization axis is directed at 90°. This means that the polarization direction of the polarized light exiting from liquid crystal layer 64A differs from the polarization direction of the polarized light incident on liquid crystal layer 64A by 90°.

### [1-4. Operation of Display Device]

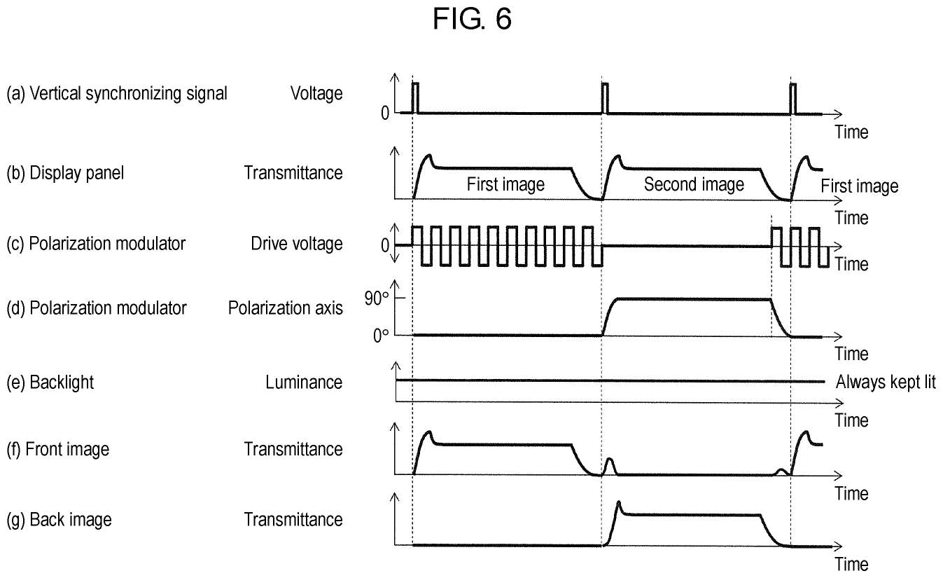

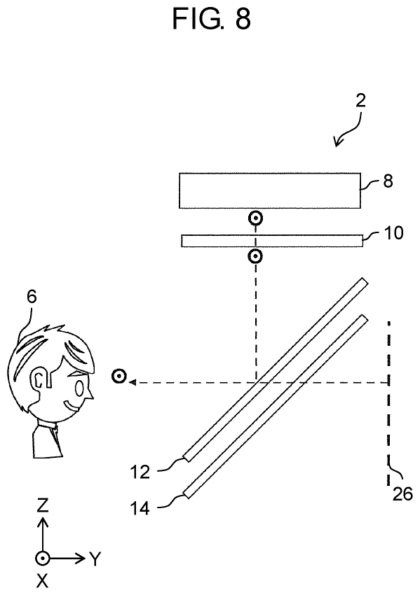

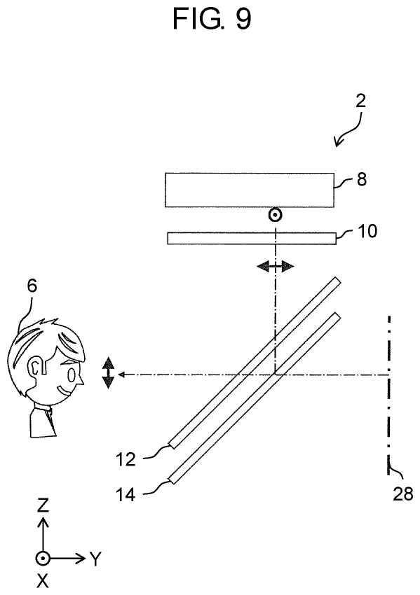

With reference to FIGS. 6 to 9, a description is provided next of operation of display device 2. FIG. 6 is a timing chart illustrating the operation of display device 2 according to the first exemplary embodiment. FIG. 7 illustrates image 4 that is displayed by display device 2 according to the first exemplary embodiment. FIGS. 8 and 9 illustrate the operation of display device 2 according to the first exemplary embodiment.

As illustrated in parts (a) and (b) of FIG. 6, based on the vertical synchronizing signal, image control circuit 50 causes first image 56 and second image 58 to be displayed alternately on display panel 20 in a repeated manner with the predetermined periodicity. Here timing for image control circuit 50 to switch the display on display panel 20 from one to the other of first and second images 56 and 58 is when the vertical synchronizing signal rises from a Low level to a High level. It is to be noted that in the present exemplary embodiment, backlight control circuit 54 always keeps backlight 16 lit as illustrated in part (e) of FIG. 6.

Part (a) of FIG. 7 illustrates first image 56 on liquid crystal display part 24 of display panel 20. Part (b) of FIG. 7 illustrates second image 58 on liquid crystal display part 24 of display panel 20. Part (c) of FIG. 7 illustrates image 4 that is visually perceived by user 6. As illustrated in parts (a) and (b) of FIG. 7, image control circuit 50 causes first image 56 to be displayed, on liquid crystal display part 24 of display panel 20, at a position that is shifted distance D in a predetermined direction (negative Y-axis direction) from a display position of second image 58 on liquid crystal display part 24. It is to be noted that distance D is set so that as illustrated in part (c) of FIG. 7, front image 26 and back image 28 are perfectly superposed when viewed from user 6.

As illustrated in part (c) of FIG. 6, polarization modulator control circuit 48 controls the drive voltage to apply to polarization modulator 10 based on the vertical synchronizing signal. Here timing for polarization modulator control circuit 48 to switch from one to the other of a case of applying the drive voltage to polarization modulator 10 and a case of not applying the drive voltage is when the vertical synchronizing signal rises from the Low level to the High level.

As illustrated in parts (b) to (d) of FIG. 6, the drive voltage is applied to polarization modulator 10 in a period in which first image 56 is displayed on display panel 20, so that polarization modulator 10 is switched to the first state in which its polarization axis is directed at 0°. Therefore, the S-polarized light (representing first image 56) exiting from liquid crystal display module 8 is maintained as the S-polarized light by polarization modulator 10 as illustrated in FIG. 8. The S-polarized light coming from polarization modulator 10 is reflected toward user 6 by first mirror 12. Here front image 26 corresponding to first image 56 is displayed at the position that is in substantially symmetrical relation to user 6 with respect to first mirror 12 as illustrated in part (f) of FIG. 6 and FIG. 8.

On the other hand, as illustrated in parts (b) to (d) of FIG. 6, the drive voltage is not applied to polarization modulator 10 in a period in which second image 58 is displayed on display panel 20, so that polarization modulator 10 is switched to the second state in which its polarization axis is directed at 90°. Therefore, the S-polarized light (representing second image 58) exiting from liquid crystal display module 8 is modulated into the P-polarized light by polarization modulator 10 as illustrated in FIG. 9. The P-polarized light coming from polarization modulator 10 passes through first mirror 12 and is then reflected toward user 6 by second mirror 14, passing through first mirror 12 again. Here back image 28 corresponding to second image 58 is displayed at the position that is in substantially symmetrical relation to user 6 with respect to second mirror 14 as illustrated in part (g) of FIG. 6 and FIG. 9.

With repetition of the above operation, front image 26 and back image 28 are displayed alternately in the repeated manner with the predetermined periodicity (e.g., 60 Hz). Since first image 56 and second image 58 differ in luminance here, front image 26 and back image 28 also differ in luminance.

On liquid crystal display part 24 of display panel 20, first image 56 is displayed at the position that is shifted in the negative Y-axis direction from the display position of second image 58, so that front image 26 and back image 28 are perfectly superposed when viewed from user 6. If first image 56 and second image 58 are displayed at the same display position on liquid crystal display part 24 of display panel 20, front image 26 and back image 28 overlap with each other while being shifted from each other along a Z-axis when viewed from user 6.

Through the optical illusion phenomenon in which front image 26 and back image 28 differing in luminance are fused into the one image, stereoscopic image 4 (refer to FIG. 1) is thus displayed.

### [1-5. Effects]

As described above, display device 2 includes display panel 20 that displays the image, backlight 16 that irradiates the back surface of display panel 20 with the light, polarization modulator 10 that modulates the light representing the image of display panel 20 into either one of the first polarized light and the second polarized light that differ in polarization direction, first mirror 12 that is inclined relative to display panel 20, reflects toward user 6 the first polarized light that comes from polarization modulator 10, and transmits the second polarized light that comes from polarization modulator 10, and second mirror 14 that is in spaced and opposed relation to first mirror 12 and reflects toward user 6 the second polarized light that passes through first mirror 12.

First mirror 12 and second mirror 14 are thus inclined relative to display panel 20, so that front image 26 that is formed by the first polarized light reflected by first mirror 12 and back image 28 that is formed by the second polarized light reflected by second mirror 14 can be fused into stereoscopic image 4 for display. Because the light coming from backlight 16 only has to pass through one display panel 20, luminance of backlight 16 can be suppressed as compared with cases where light of backlight 16 passes through two display panels as described in “BACKGROUND ART”, and therefore, utilization efficiency of light of backlight 16 can be increased.

Display device 2 also includes image control circuit 50 that controls the image which is displayed on display panel 20, and polarization modulator control circuit 48 that drivingly controls polarization modulator 10. Image control circuit 50 causes display panel 20 to display first image 56 and second image 58 alternately. When display panel 20 displays first image 56, polarization modulator control circuit 48 switches polarization modulator 10 to the first state in which the light representing first image 56 is modulated into the first polarized light. When display panel 20 displays the second image 58, polarization modulator control circuit 48 switches polarization modulator 10 to the second state in which the light representing second image 58 is modulated into the second polarized light.

Thus stereoscopic image 4 can be displayed by means of polarization modulator 10, which is what is called the active retarder.

Based on the vertical synchronizing signal, image control circuit 50 switches the display on display panel 20 from one to the other of first and second images 56 and 58. Based on the vertical synchronizing signal, polarization modulator control circuit 48 switches polarization modulator 10 from one to the other of the first and second states.

Therefore, the switching of the display on display panel 20 from one to the other of first and second images 56 and 58 and the switching of polarization modulator 10 from one to the other of the first and second states can be synchronized.

Image control circuit 50 causes first image 56 to be displayed, on display panel 20, at the position that is shifted in the predetermined direction from the display position of second image 58 on display panel 20.

Thus display device 2 enables front image 26 formed by first image 56 and back image 28 formed by second image 58 to be displayed in perfectly superposed relation when viewed from user 6.

First mirror 12 is the polarization beam splitter. Second mirror 14 is the reflecting mirror.

Therefore, display device 2 can have the simplified configuration.

### Second Exemplary Embodiment

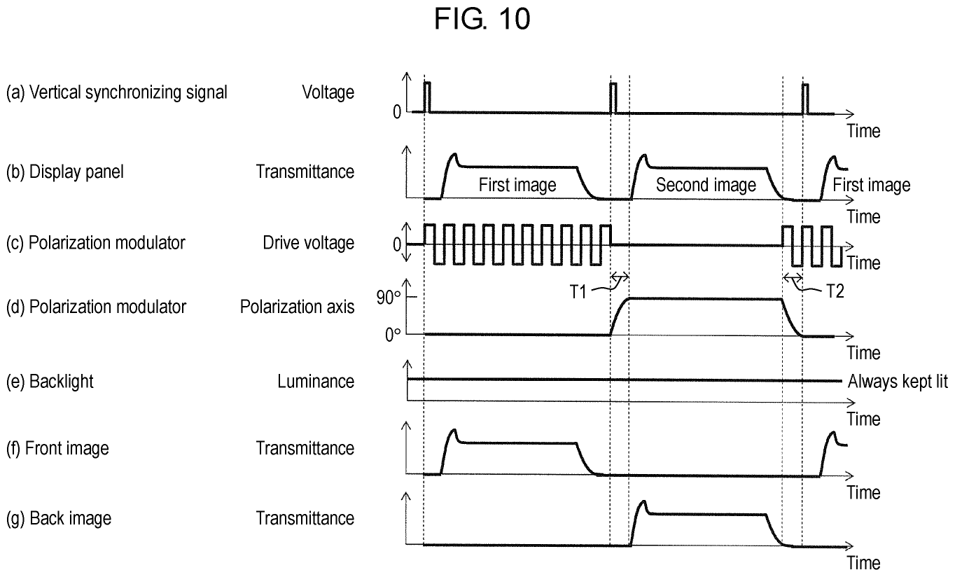

With reference to FIG. 10, a description is provided next of operation of display device 2B (refer to FIG. 2) according to the second exemplary embodiment. FIG. 10 is a timing chart illustrating the operation of display device 2B according to the second exemplary embodiment. It is to be noted that in the following exemplary embodiments, constituent elements identical with those in the above-described first exemplary embodiment have the same reference characters and are not described.

As illustrated in part (d) of FIG. 10, period T1 is a transient response period in which polarization modulator 10 (refer to FIG. 1) is switched from the first state to the second state. Period T2 is a transient response period in which polarization modulator 10 is switched from the second state to the first state. During these periods T1 and T2, a portion of S-polarized light exiting from liquid crystal display module 8 (refer to FIG. 1) is maintained as S-polarized light by polarization modulator 10, while a remainder of the S-polarized light exiting from liquid crystal display module 8 is modulated into P-polarized light by polarization modulator 10. Therefore, if second image 58 is displayed on display panel 20 (refer to FIG. 1) during periods T1 and T2, what is caused is so-called crosstalk such that second image 58 appears both on front image 26 and back image 28 (refer to FIG. 1).

For that reason, image control circuit 50B (refer to FIG. 2) of display device 2B according to the second exemplary embodiment does not cause display panel 20 to display second image 58 (or causes display panel 20 to perform black display) during periods T1 and T2 as illustrated in part (b) of FIG. 10. Neither front image 26 nor back image 28 is thus displayed during periods T1 and T2, so that the above-mentioned crosstalk can be suppressed.

### Third Exemplary Embodiment

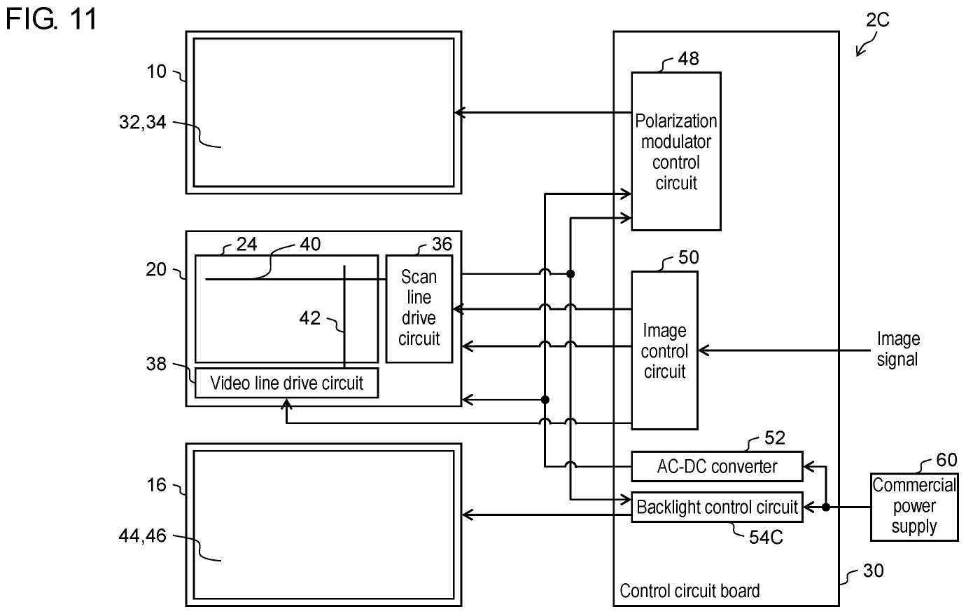

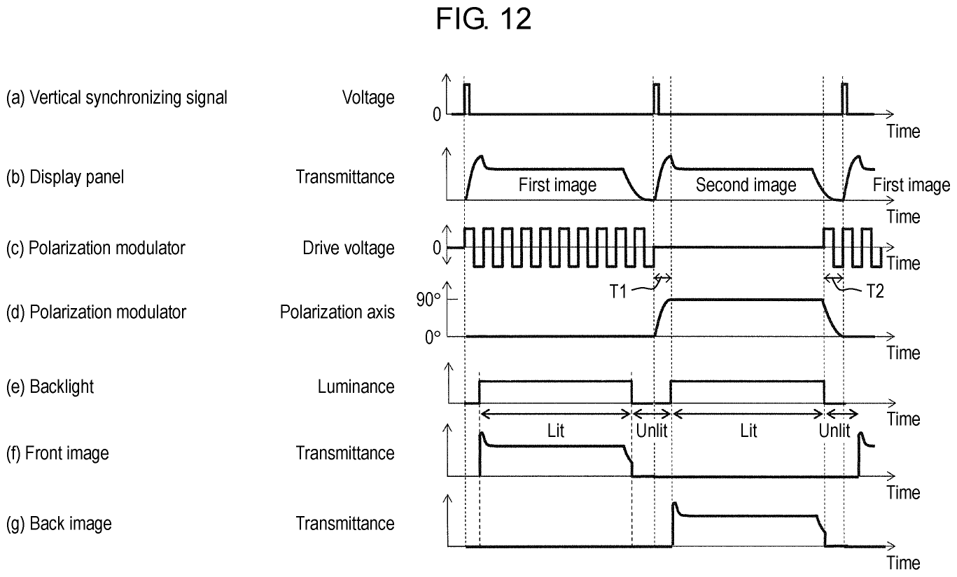

With reference to FIGS. 11 and 12, the third exemplary embodiment is described next.

### [3-1. Operation of Display Device]

With reference to FIGS. 11 and 12, a description is provided of operation of display device 2C according to the third exemplary embodiment. FIG. 11 is a block diagram illustrating an electrical configuration of display device 2C according to the third exemplary embodiment. FIG. 12 is a timing chart illustrating the operation of display device 2C according to the third exemplary embodiment.

As illustrated in FIG. 11, backlight control circuit 54C of display device 2C according to the third exemplary embodiment controls lighting of backlight 16 based on a vertical synchronizing signal coming from display panel 20. Specifically, backlight control circuit 54C lights backlight 16 during a period in which one of first and second images 56 and 58 is displayed on display panel 20 as illustrated in parts (b) and (e) of FIG. 12. Backlight control circuit 54C turns off backlight 16 when entering a period (including period T1 or T2) in which a display on display panel 20 is switched from one to the other of first and second images 56 and 58.

Neither front image 26 nor back image 28 (refer to FIG. 1) is thus displayed during periods T1 and T2 as illustrated in parts (f) and (g) of FIG. 12, so that crosstalk mentioned above can be suppressed.

### [3-2. Effect]

As described above, display device 2C of the present exemplary embodiment also includes backlight control circuit 54C that controls lighting of backlight 16. Backlight control circuit 54C lights backlight 16 during the period in which one of first and second images 56 and 58 is displayed on display panel 20 and turns off backlight 16 when entering the period in which the display on display panel 20 is switched from one to the other of first and second images 56 and 58.

Neither front image 26 nor back image 28 is thus displayed during the above-mentioned periods, so that the crosstalk mentioned above can be suppressed.

### Fourth Exemplary Embodiment

### [4-1. Configuration of Display Device]

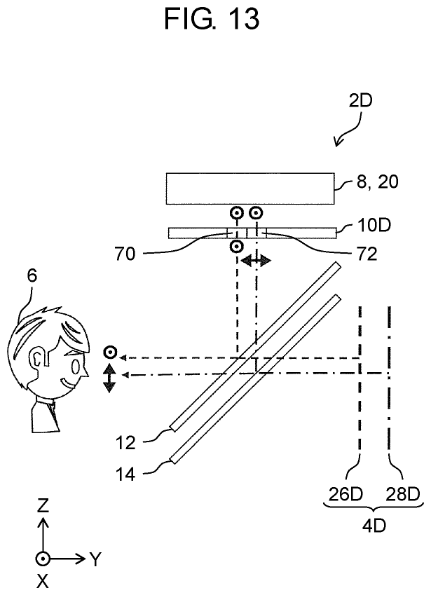

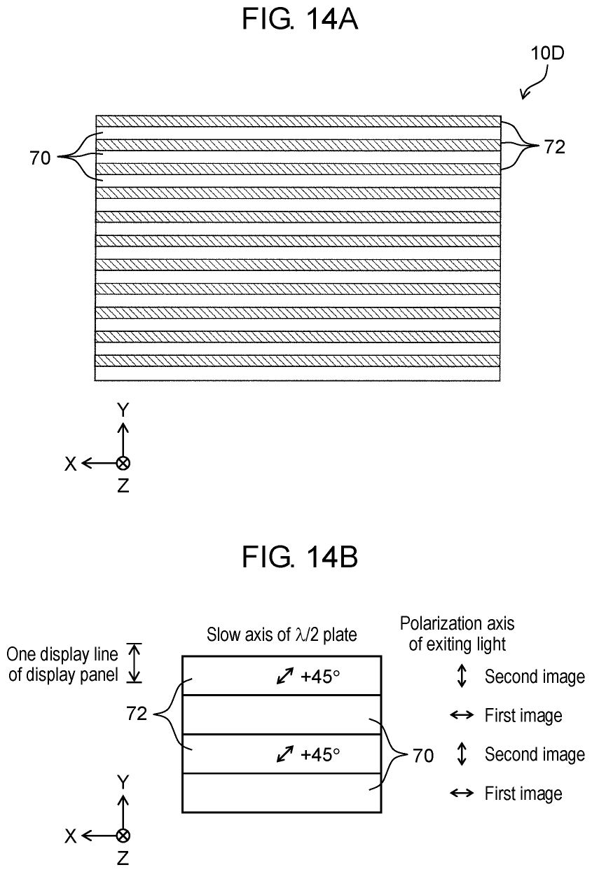

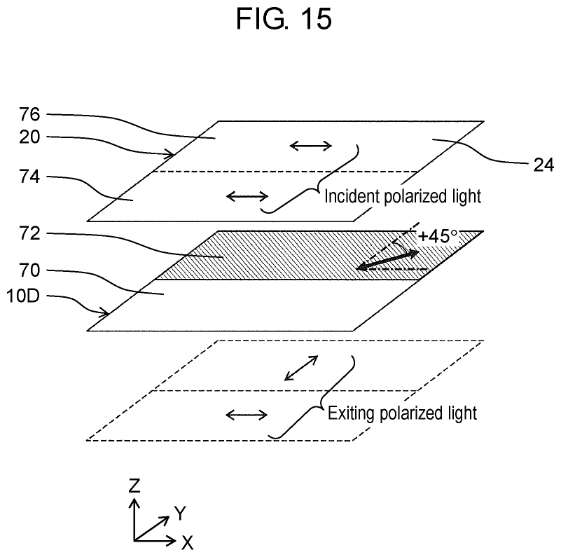

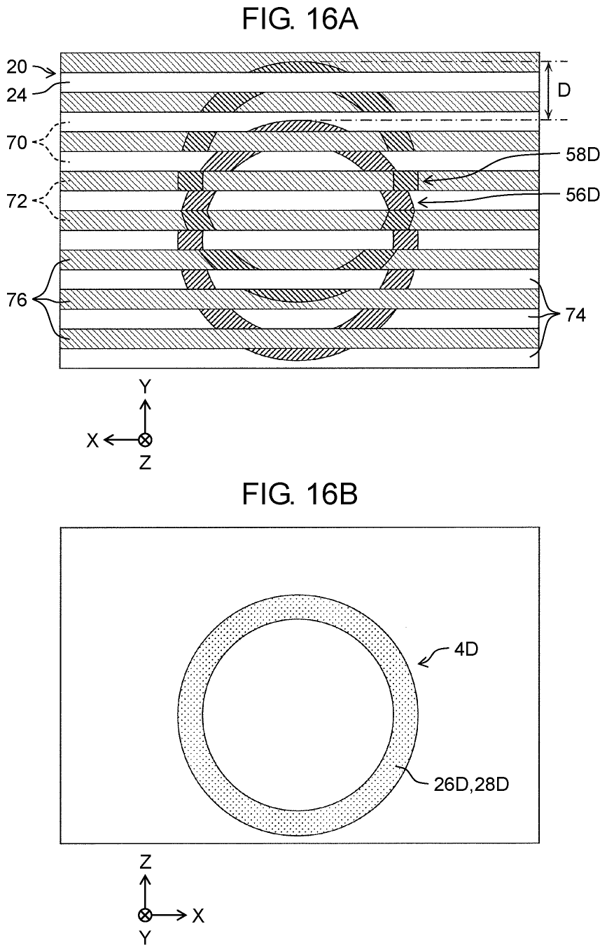

With reference to FIGS. 13 to 16B, a description is provided next of a configuration of display device 2D according to the fourth exemplary embodiment. FIG. 13 illustrates the configuration of display device 2D according to the fourth exemplary embodiment. FIGS. 14A, 14B, and 15 illustrate structure of polarization modulator 10D of display device 2D according to the fourth exemplary embodiment. FIGS. 16A and 16B illustrate image 4D that is displayed by display device 2D according to the fourth exemplary embodiment. In FIG. 16A, display panel 20 and polarization modulator 10D are shown in superposed relationship for convenience of explanation.

As illustrated in FIG. 13, display device 2D according to the fourth exemplary embodiment includes polarization modulator 10D in place of polarization modulator 10 described in the above first exemplary embodiment. Polarization modulator 10D is what is called a pattern retarder.

As illustrated in FIG. 14A, polarization modulator 10D includes a plurality of first retardation areas 70 and a plurality of second retardation areas 72. First retardation areas 70 and second retardation areas 72 are arranged alternately in stripes in a depthwise direction (along a Y-axis). The plurality of first retardation areas 70 and the plurality of second retardation areas 72 substantially parallel scan lines extending along an X-axis of display panel 20. As illustrated in FIG. 14B, first retardation area 70 and second retardation area 72 each have roughly the same Y-axis dimension as one display line of liquid crystal display part 24 of display panel 20. It is to be noted that first retardation area 70 and second retardation area 72 may each have a Y-axis dimension that is roughly equal to an X-axis dimension of a plurality of adjacent display lines.

Each of first retardation areas 70 is composed of a transparent glass plate, while each of second retardation areas 72 is composed of a λ/2 plate (half-wave plate). As illustrated in FIG. 14B, a slow axis of the λ/2 plate forming second retardation area 72 is directed to be inclined at +45° relative to the direction (along the Y-axis) in which first retardation areas 70 and second retardation areas 72 are arranged.

Included in S-polarized light coming from display panel 20, S-polarized light incident on first retardation area 70 of polarization modulator 10D is maintained as the S-polarized light by the glass plate when exiting from first retardation area 70 as illustrated in FIG. 15. Included in the S-polarized light coming from display panel 20, S-polarized light incident on second retardation area 72 of polarization modulator 10D is modulated by the λ/2 plate into P-polarized light which exits from second retardation area 72.

As illustrated in FIG. 16A, first image 56D and second image 58D are displayed simultaneously on liquid crystal display part 24 of display panel 20. Liquid crystal display part 24 includes a plurality of the display lines arranged alternately in stripes in the depthwise direction (along the Y-axis). Among the plurality of the display lines, even-row display lines are where first display areas 74 are respectively disposed to display first image 56D. Among the plurality of the display lines, odd-row display lines are where second display areas 76 are respectively disposed to display second image 58D. On liquid crystal display part 24, first image 56D is displayed at a position that is shifted predetermined distance D in a predetermined direction (negative Y-axis direction) from a display position of second image 58D on liquid crystal display part 24 as in the above-described first exemplary embodiment.

It is to be noted that as illustrated in FIG. 16A, the plurality of first display areas 74 of display panel 20 are disposed to correspond respectively to the plurality of first retardation areas 70 of polarization modulator 10D. Moreover, the plurality of second display areas 76 of display panel 20 are disposed to correspond respectively to the plurality of second retardation areas 72 of polarization modulator 10D. For convenience of explanation, a Y-axis dimension of each of first and second display areas 74 and 76 is illustrated larger than its actual dimension in FIG. 16A.

In the present exemplary embodiment, first retardation area 70 and second retardation area 72 are composed of the glass plate and the λ/2 plate, respectively; however, first retardation area 70 and second retardation area 72 may respectively be composed of the λ/2 plate and the glass plate in a contrary manner. In other words, only either one of first retardation area 70 and second retardation area 72 may be composed of the λ/2 plate.

### [4-2. Operation of Display Device]

With reference to FIG. 13, a description is provided next of operation of display device 2D according to the fourth exemplary embodiment.

As described above, first display areas 74 of liquid crystal display part 24 of display panel 20 display first image 56D, while second display areas 76 display second image 58D.

As illustrated in FIG. 13, the S-polarized light (representing first image 56D) coming from each of the plurality of first display areas 74 of display panel 20 is maintained as the S-polarized light by each of the plurality of first retardation areas 70 of polarization modulator 10D. The S-polarized light coming from each of the plurality of first retardation areas 70 of polarization modulator 10D is reflected toward user 6 by first mirror 12. Here front image 26D corresponding to first image 56D is displayed at a position that is in substantially symmetrical relation to user 6 with respect to first mirror 12 as illustrated in FIG. 13.

The S-polarized light (representing second image 58D) coming from each of the plurality of second display areas 76 of display panel 20 is modulated into the P-polarized light by each of the plurality of second retardation areas 72 of polarization modulator 10D. The P-polarized light coming from each of the plurality of second retardation areas 72 of polarization modulator 10D passes through first mirror 12 and is then reflected toward user 6 by second mirror 14, passing through first mirror 12 again. Here back image 28D corresponding to second image 58D is displayed at a position that is in substantially symmetrical relation to user 6 with respect to second mirror 14 as illustrated in FIG. 13.

In the above way, front image 26D and back image 28D are displayed simultaneously as illustrated in FIG. 16B. Through an optical illusion phenomenon in which front and back images 26D and 28D differing in luminance are fused into one image, stereoscopic image 4D is displayed.

It is to be noted that back image 28D has reduced luminance compared with front image 26D because the P-polarized light, resulting from the modulation of the S-polarized light that comes from second display area 76 of display panel 20, passes through first mirror 12 twice. For that reason, an adjustment may be made by changing luminance of each of first and second images 56D and 58D or adjusting an area ratio between first retardation areas 70 and second retardation areas 72 to effect adjusted luminance of each of front and back images 26D and 28D.

### [4-3. Effects]

In the present exemplary embodiment, display device 2D described above also includes image control circuit 50 that controls the images to be displayed on display panel 20. Image control circuit 50 causes first display areas 74 of display panel 20 to display first image 56D and causes second display areas 76 of display panel 20 to display second image 58D. Polarization modulator 10D includes first retardation areas 70 that correspond respectively to first display areas 74 to each modulate the light representing first image 56D of display panel 20 into the first polarized light, and second retardation areas 72 that correspond respectively to second display areas 76 to each modulate the light representing second image 58D of display panel 20 into the second polarized light.

Thus stereoscopic image 4D can be displayed by means of polarization modulator 10D, which is what is called the pattern retarder.

Only either one of first retardation area 70 and second retardation area 72 is composed of the λ/2 plate.

Polarization modulator 10D can thus have the simplified structure.

### [4-4. Modifications of Polarization Modulator]

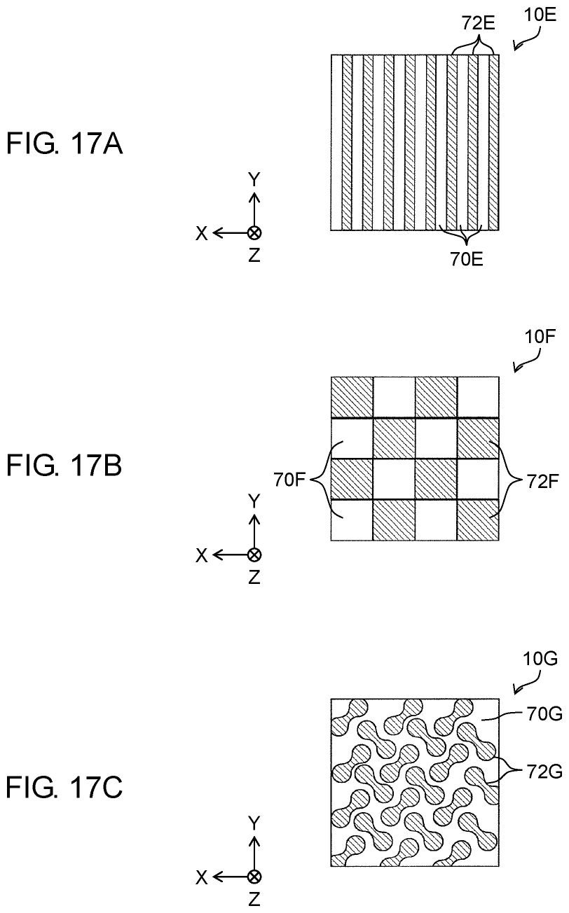

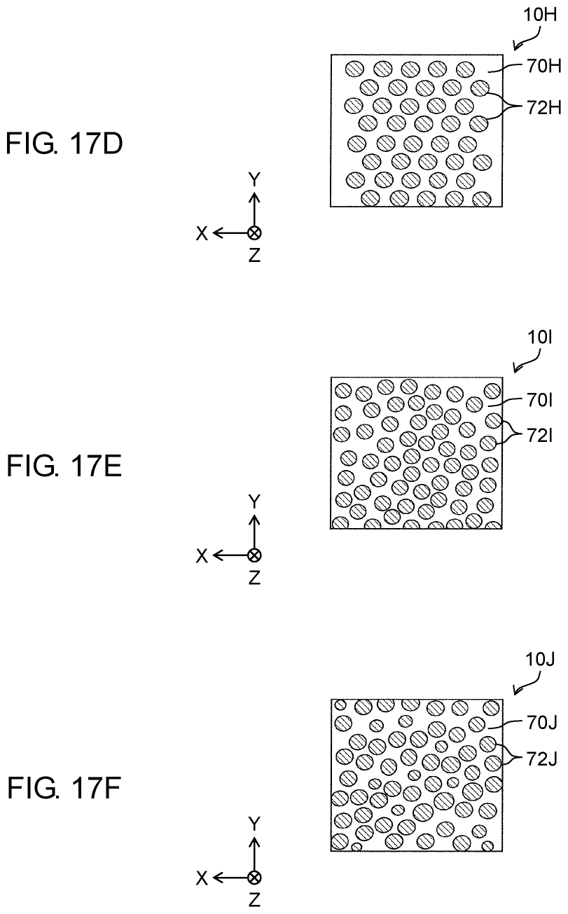

With reference to FIGS. 17A to 17F, a description is provided next of structure of each of polarization modulators 10E to 10J according to modifications 1 to 6 of the fourth exemplary embodiment. FIGS. 17A to 17F respectively illustrate the structures of polarization modulators 10E to 10J according to modifications 1 to 6 of the fourth exemplary embodiment.

As illustrated in FIG. 17A, polarization modulator 10E according to modification 1 includes first retardation areas 70E and second retardation areas 72E that are arranged alternately in stripes in an X-axis direction. First retardation areas 70E and second retardation areas 72E are substantially perpendicular to the scan lines extending along the X-axis of display panel 20 (refer to FIG. 13).

First retardation area 70E and second retardation area 72E each have the same X-axis dimension as one display line of liquid crystal display part 24 of display panel 20. It is to be noted that first retardation area 70E and second retardation area 72E may each have an X-axis dimension that is equal to an X-axis dimension of a plurality of adjacent display lines.

As illustrated in FIG. 17B, polarization modulator 10F according to modification 2 includes a plurality of first retardation areas 70F and a plurality of second retardation areas 72F that are arranged alternately in a staggered pattern. First retardation areas 70F and second retardation areas 72F are each formed to be rectangular.

As illustrated in FIG. 17C, polarization modulator 10G according to modification 3 includes a plurality of second retardation areas 72G that are staggered. Second retardation areas 72G are each formed to be of irregular shape (gourd shape). First retardation area 70G is disposed to fill an area other than the plurality of second retardation areas 72G.

As illustrated in FIG. 17D, polarization modulator 10H according to modification 4 includes a plurality of second retardation areas 72H that are staggered. The plurality of second retardation areas 72H are formed to be circular and uniform in size. First retardation area 70H is disposed to fill an area other than the plurality of second retardation areas 72H.

As illustrated in FIG. 17E, polarization modulator 10I according to modification 5 includes a plurality of second retardation areas 72I that are nonuniformly disposed. The plurality of second retardation areas 72I are formed to be circular and uniform in size. First retardation area 70I is disposed to fill an area other than the plurality of second retardation areas 72I.

As illustrated in FIG. 17F, polarization modulator 10J according to modification 6 includes a plurality of second retardation areas 72J that are nonuniformly disposed. The plurality of second retardation areas 72J are formed to be circular and are not uniform in size. First retardation area 70J is disposed to fill an area other than the plurality of second retardation areas 72J.

### Fifth Exemplary Embodiment

### [5-1. Configuration of Display Device]

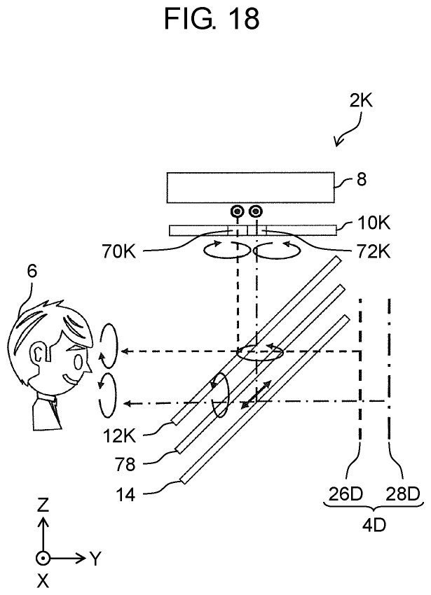

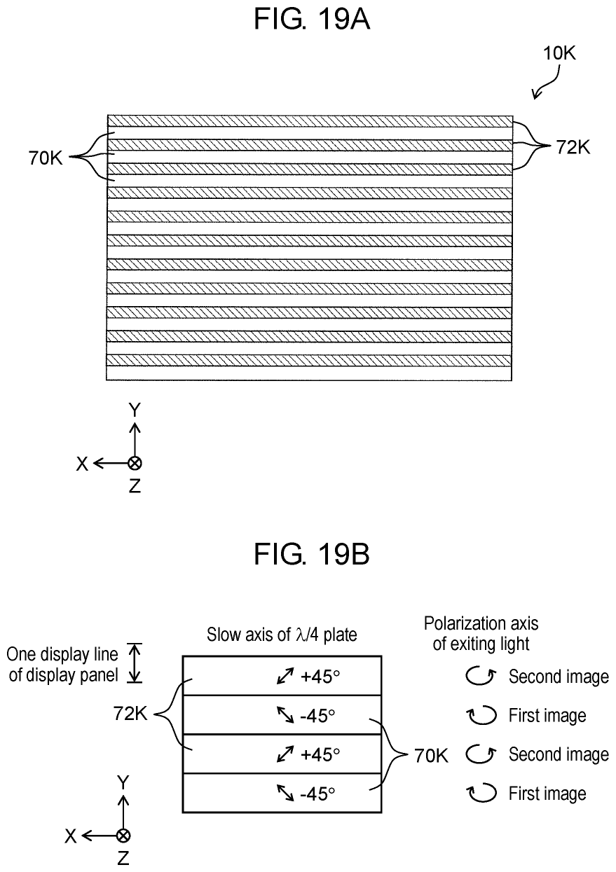

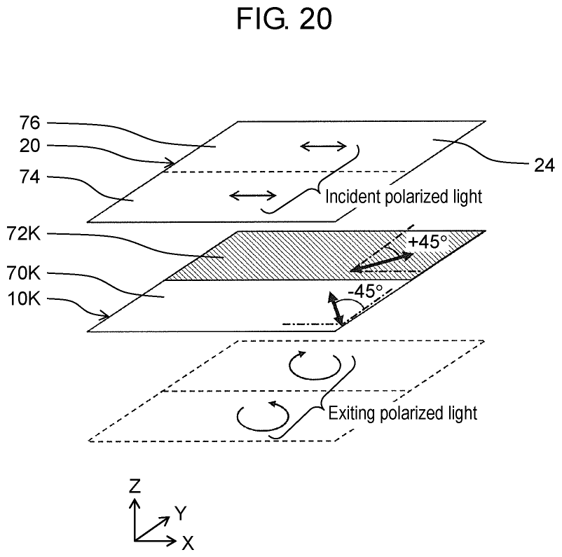

With reference to FIGS. 18 to 20, a description is provided next of a configuration of display device 2K according to the fifth exemplary embodiment. FIG. 18 illustrates the configuration of display device 2K according to the fifth exemplary embodiment. FIGS. 19A, 19B, and 20 illustrate structure of polarization modulator 10K of display device 2K according to the fifth exemplary embodiment.

As illustrated in FIG. 18, display device 2K according to the fifth exemplary embodiment includes polarization modulator 10K in place of polarization modulator 10 described in the above first exemplary embodiment. Polarization modulator 10K is what is called a pattern retarder. Disposed between first mirror 12K and second mirror 14 is μ/4 film 78.

As illustrated in FIG. 19A, polarization modulator 10K includes a plurality of first retardation areas 70K and a plurality of second retardation areas 72K. First retardation areas 70K and second retardation areas 72K are arranged alternately in stripes in a depthwise direction (along a Y-axis). First retardation areas 70K and second retardation areas 72K substantially parallel scan lines extending along an X-axis of display panel 20. As illustrated in FIG. 19B, first retardation area 70K and second retardation area 72K each have roughly the same Y-axis dimension as one display line of liquid crystal display part 24 of display panel 20. It is to be noted that first retardation area 70K and second retardation area 72K may each have a Y-axis dimension that is roughly equal to an X-axis dimension of a plurality of adjacent display lines.

Each of first retardation areas 70K is composed of a first λ/4 plate (quarter-wave plate) having a first slow axis. Each of second retardation areas 72K is composed of a second λ/4 plate having a second slow axis. As illustrated in FIG. 19B, the first slow axis of the first λ/4 plate forming first retardation area 70K is directed to be inclined at −45° relative to the direction (along the Y-axis) in which first retardation areas 70K and second retardation areas 72K are arranged. The second slow axis of the second λ/4 plate forming second retardation area 72K is directed to be inclined at +45° relative to the direction (along the Y-axis) in which first retardation areas 70K and second retardation areas 72K are arranged. This means that the direction of the second slow axis differs from the direction of the first slow axis by 90°.

Included in S-polarized light coming from display panel 20, S-polarized light incident on first retardation area 70K of polarization modulator 10K is modulated by the first λ/4 plate into left-handed circularly polarized light (an example of the first polarized light) which exits from first retardation area 70K as illustrated in FIG. 20. Included in the S-polarized light coming from display panel 20, S-polarized light incident on second retardation area 72K of polarization modulator 10K is modulated by the second λ/4 plate into right-handed circularly polarized light (an example of the second polarized light) which exits from second retardation area 72K.

As in the above-described fourth exemplary embodiment, first image 56D and second image 58D are displayed simultaneously on liquid crystal display part 24 of display panel 20 as illustrated in FIGS. 16A and 18.

It is to be noted that the plurality of first display areas 74 (refer to FIG. 16A) of display panel 20 are disposed to correspond respectively to the plurality of first retardation areas 70K of polarization modulator 10K. Moreover, the plurality of second display areas 76 (refer to FIG. 16A) of display panel 20 are disposed to correspond respectively to the plurality of second retardation areas 72K of polarization modulator 10K.

First mirror 12K reflects toward user 6 the right-handed circularly polarized light coming from polarization modulator 10K and transmits the left-handed circularly polarized light coming from polarization modulator 10K.

### [5-2. Operation of Display Device]

With reference to FIG. 18, a description is provided next of operation of display device 2K according to the fifth exemplary embodiment.

As described earlier, first display areas 74 of liquid crystal display part 24 of display panel 20 display first image 56D, while second display areas 76 display second image 58D.

As illustrated in FIG. 18, the S-polarized light (representing first image 56D) coming from each of the plurality of first display areas 74 is modulated into the right-handed circularly polarized light by each of the plurality of first retardation areas 70K of polarization modulator 10K. The right-handed circularly polarized light coming from each of the plurality of first retardation areas 70K of polarization modulator 10K is reflected toward user 6 by first mirror 12K. Here front image 26D corresponding to first image 56D is displayed at a position that is in substantially symmetrical relation to user 6 with respect to first mirror 12K as illustrated in FIG. 18.

The S-polarized light (representing second image 58D) coming from each of the plurality of second display areas 76 is modulated into the left-handed circularly polarized light by each of the plurality of second retardation areas 72K of polarization modulator 10K. The left-handed circularly polarized light coming from each of the plurality of second retardation areas 72K of polarization modulator 10K passes through first mirror 12K and then passes through λ/4 film 78, thus being converted to linearly polarized light (P-polarized light in the FIG. 18 example). The linearly polarized light (P-polarized light) exiting from λ/4 film 78 is reflected toward user 6 by second mirror 14. The linearly polarized light (P-polarized light) reflecting off second mirror 14 passes through λ/4 film 78, thus being converted to the left-handed circularly polarized light which then passes through first mirror 12 again. Here back image 28D corresponding to second image 58D is displayed at a position that is in substantially symmetrical relation to user 6 with respect to second mirror 14 as illustrated in FIG. 18.

In the above way, front image 26D and back image 28D are displayed simultaneously. Through an optical illusion phenomenon in which front and back images 26D and 28D differing in luminance are fused into one image, stereoscopic image 4D is displayed.

### [5-3. Effect]

As described above, first retardation areas 70K of the present exemplary embodiment are each composed of the first λ/4 plate having the first slow axis. Second retardation areas 72K are each composed of the second λ/4 plate having the second slow axis that differs in direction from the first slow axis by 90°.

Polarization modulator 10K can thus have the simplified structure.

### Sixth Exemplary Embodiment

### [6-1. Configuration of Display Device]

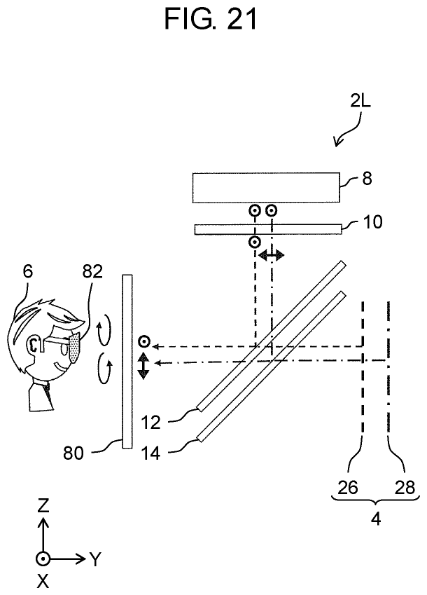

With reference to FIG. 21, a description is provided next of a configuration of display device 2L according to the sixth exemplary embodiment. FIG. 21 illustrates the configuration of display device 2L according to the sixth exemplary embodiment.

As illustrated in FIG. 21, display device 2L according to the sixth exemplary embodiment includes λ/4 sheet 80 in addition to those constituent elements described in the above first exemplary embodiment. This λ/4 sheet 80 is disposed between first mirror 12 and user 6.

S-polarized light reflected by first mirror 12 passes through λ/4 sheet 80, thus being converted to right-handed circularly polarized light. P-polarized light reflected by second mirror 14 passes through λ/4 sheet 80, thus being converted to left-handed circularly polarized light.

Therefore, even when user 6 wears polarized sunglasses 82 that block either one of S-polarized light and P-polarized light, the right-handed circularly polarized light and the left-handed circularly polarized light that come from λ/4 sheet 80 pass through polarized sunglasses 82. As a result, user 6 can stereoscopically perceive image 4.

### [6-2. Effect]

As described above, the first polarized light reflected by first mirror 12 and the second polarized light reflected by second mirror 14 are each linearly polarized light in the present exemplary embodiment. Display device 2L also includes λ/4 sheet 80 that converts the first polarized light (linearly polarized light) reflected by first mirror 12 and the second polarized light (linearly polarized light) reflected by second mirror 14 each to the circularly polarized light.

Therefore, even when wearing polarized sunglasses 82, user 6 can stereoscopically perceive image 4.

### Seventh Exemplary Embodiment

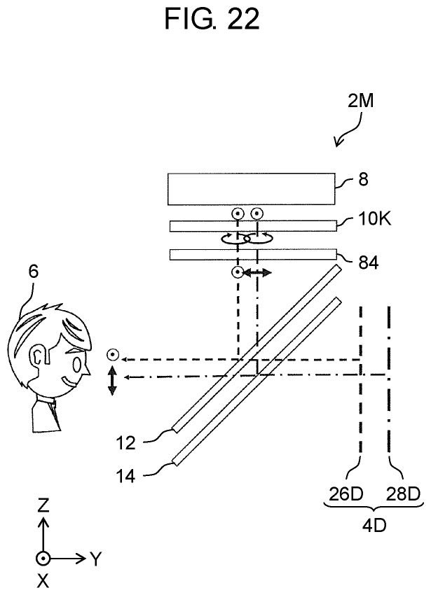

With reference to FIG. 22, a description is provided next of a configuration of display device 2M according to the seventh exemplary embodiment. FIG. 22 illustrates the configuration of display device 2M according to the seventh exemplary embodiment.

As illustrated in FIG. 22, display device 2M according to the seventh exemplary embodiment includes λ/4 film 84 that is disposed differently as compared with the corresponding one of the above fifth exemplary embodiment. Specifically, λ/4 film 84 is disposed between polarization modulator 10K that is the same as that of the above fifth exemplary embodiment and converts linearly polarized light to circularly polarized light, and first mirror 12 that is the same as that of the first exemplary embodiment. This λ/4 film 84 has a slow axis at an angle of about 45° relative to a polarization axis of the light exiting from liquid crystal display module 8.

Thus the circularly polarized light and the circularly polarized light that are incident on λ/4 film 84 are respectively converted to the P-polarized light and the S-polarized light that are orthogonal to each other. The S-polarized light exiting from λ/4 film 84 is reflected toward user 6 by first mirror 12. Here front image 26D corresponding to first image 56D (refer to FIG. 16A) is displayed at a position that is in substantially symmetrical relation to user 6 with respect to first mirror 12 as illustrated in FIG. 22.

The P-polarized light exiting from λ/4 film 84 passes through first mirror 12 and is then reflected toward user 6 by second mirror 14, passing through first mirror 12 again. Here back image 28D corresponding to second image 58D (refer to FIG. 16A) is displayed at a position that is in substantially symmetrical relation to user 6 with respect to second mirror 14 as illustrated in FIG. 22.

### Other Exemplary Embodiments

The exemplary embodiments have been described above as being illustrative of the technique disclosed in the present application. However, the technique of the present disclosure is not limited to these exemplary embodiments and is also applicable to exemplary embodiments including appropriate changes, replacements, additions, and omissions. Moreover, the constituent elements described in the above exemplary embodiments and the modifications can be combined in a new exemplary embodiment.

The following illustration is provided of another exemplary embodiment.

In the example described in each of the above exemplary embodiments, display device 2 (2B, 2C, 2D, 2K, 2L, or 2M) is mounted to the vehicle; however, this example is not limiting. The display device may be used as, for example, a television receiver or the like.

The above descriptions have been provided of the exemplary embodiments that are illustrative of the technique of the present disclosure. And the appended drawings and the detailed descriptions have been provided accordingly.

Therefore, the constituent elements illustrated and described in the appended drawings and the detailed descriptions may include, for illustration of the above technique, not only the constituent elements that are essential for solving the problem but also the constituent elements that are not essential for solving the problem. Therefore, those inessential constituent elements that are illustrated in the appended drawings or described in the detailed description should not immediately be acknowledged as essential.

Since the above exemplary embodiments are intended to be illustrative of the technique of the present disclosure, various modifications, replacements, additions, omissions, and others can be made within the scope of the claims or equivalents of the claims.

### INDUSTRIAL APPLICABILITY

The present disclosure is applicable to a display device that displays images. Specifically, the present disclosure is applicable to, for example, a DFD display device or the like.

### REFERENCE MARKS IN THE DRAWINGS

2, 2B, 2C, 2D, 2K, 2L, 2M: display device

4, 4D: image

6: user

8: liquid crystal display module

10, 10A, 10D, 10E, 10F, 10G, 10H, 10I, 10J, 10K: polarization modulator

12, 12K: first mirror

14: second mirror

16: backlight

18: rear polarizing film

20: display panel

22: front polarizing film

24: liquid crystal display part

26, 26D: front image

28, 28D: back image

30: control circuit board

32, 34: transparent electrode

36: scan line drive circuit

38: video line drive circuit

40: scan line

42: video line

44: LED light source

46: light guide plate

48: polarization modulator control circuit

50, 50B: image control circuit

52: AC-DC converter

54, 54C: backlight control circuit

56, 56D: first image

58, 58D: second image

60: commercial power supply

62, 66: glass substrate

64, 64A: liquid crystal layer

68: liquid crystal molecule

70, 70E, 70F, 70G, 70H, 70I, 70J, 70K: first retardation area

72, 72E, 72F, 72G, 72H, 72I, 72J, 72K: second retardation area

74: first display area

76: second display area

78, 84: λ/4 film

80: λ/4 sheet

82: polarized sunglasses

1. A display device comprising:
a display panel that displays an image;
a backlight that irradiates a back surface of the display panel with light;
a polarization modulator that modulates light representing the image of the display panel into either one of first polarized light and second polarized light that differ in polarization direction;
a first mirror that reflects toward a user the first polarized light that comes from the polarization modulator, and transmits the second polarized light that comes from the polarization modulator, the first mirror being inclined relative to the display panel; and
a second mirror that reflects toward the user the second polarized light that passes through the first mirror, the second mirror being in spaced and parallel relation to the first mirror.

2. The display device according to claim 1, further comprising:
a display controller that controls the image that is displayed on the display panel; and
a drive controller that drivingly controls the polarization modulator;
wherein the display controller causes the display panel to display a first image and a second image alternately,
wherein when the display panel displays the first image, the drive controller switches the polarization modulator to a first state that effects modulation of light representing the first image into the first polarized light, and
wherein when the display panel displays the second image, the drive controller switches the polarization modulator to a second state that effects modulation of light representing the second image into the second polarized light.

3. The display device according to claim 2, wherein:
the display controller switches, based on a vertical synchronizing signal, the display on the display panel from one of the first image and the second image to another of the first image and the second image; and
the drive controller switches, based on the vertical synchronizing signal, the polarization modulator from one of the first state and the second state to another of the first state and the second state.

4. The display device according to claim 2, further comprising a lighting controller that controls lighting of the backlight,
wherein the lighting controller causes the backlight to perform the irradiation during a period in which the display panel displays one of the first image and the second image, and
wherein the lighting controller causes the backlight not to perform the irradiation during a period in which the display panel switches the image from one of the first image and the second image to another of the first image and the second image.

5. The display device according to claim 2, wherein the display controller causes the first image to be displayed, on the display panel, at a position that is shifted in a predetermined direction from a display position of the second image on the display panel.

6. The display device according to claim 1, further comprising a display controller that controls the image that is displayed on the display panel,
wherein the display controller causes a first display area of the display panel to display a first image and causes a second display area of the display panel to display a second image, and
wherein the polarization modulator includes:
a first retardation area that modulates light representing the first image of the display panel into the first polarized light, the first retardation area corresponding to the first display area; and
a second retardation area that modulates light representing the second image of the display panel into the second polarized light, the second retardation area corresponding to the second display area.

7. The display device according to claim 6, wherein only either one of the first retardation area and the second retardation area includes a λ/2 plate.

8. The display device according to claim 6, wherein:
the first retardation area includes a first λ/4 plate including a first slow axis; and
the second retardation area includes a second λ/4 plate including a second slow axis that differs in direction from the first slow axis by 90°.

9. The display device according to claim 1, wherein:
the first polarized light reflected by the first mirror and the second polarized light reflected by the second mirror are each linearly polarized light; and
the display device further comprises a λ/4 sheet that converts the first polarized light that is the linearly polarized light reflected by the first mirror and the second polarized light that is the linearly polarized light reflected by the second mirror each to circularly polarized light.

10. The display device according to claim 1, wherein:
the first mirror is a polarization beam splitter; and
the second mirror is a reflecting mirror.
